(19) United States
(12) Patent Application Publication
(10) Pub. No.: US 2017/0122838 A1
(43) Pub. Date: May 4, 2017

(54) HYDROSTATIC BEARING MONITORING SYSTEM AND METHOD

(71) Applicant: INDUSTRIAL TECHNOLOGY RESEARCH INSTITUTE, Hsinchu Hsien (TW)

(72) Inventors: Po-Hsiu Ko, Hsinchu (TW); Chin-Ming Chen, Hsinchu (TW); Shang-Te Chen, Hsinchu (TW); Hsin-Chuan Su, Hsinchu (TW); Hsi-Hung Hsiao, Hsinchu (TW); Shao-Ying Hung, Hsinchu (TW)

(21) Appl. No.: 14/969,290

(22) Filed: Dec. 15, 2015

(30) Foreign Application Priority Data
Oct. 28, 2015 (TW) 104135388

(51) Int. Cl. G01M 13/04; F16C 41/00; F16C 29/02

(52) U.S. Cl. CPC G01M 13/04; F16C 29/025; F16C 41/008; F16C 2233/00

(57) ABSTRACT

The present disclosure provides a hydrostatic bearing monitoring system and a hydrostatic bearing monitoring system method. A sensor detects a state parameter of a hydrostatic bearing device. A computing unit establishes a performance prediction model according to the state parameter, and compares the performance prediction model with reliability experimental data, so as to obtain variation of performance of the hydrostatic bearing device and provide a warning function.

### CROSS-REFERENCE TO RELATED APPLICATION

The present disclosure is based on, and claims priority from, Taiwan Application Number 104135388, filed Oct. 28, 2015, the disclosure of which is hereby incorporated by reference herein in its entirety.

### BACKGROUND

1. Technical Field

The present disclosure relates to bearing monitoring technologies, and, more particularly, to a hydrostatic bearing monitoring system and a hydrostatic bearing monitoring method.

2. Description of Related Art

Hydrostatic bearings involve feeding of hydraulic oil with a certain pressure into an oil chamber between a shaft and a bearing so as to form an oil film therebetween, thereby effectively separating metal surfaces of the bearing and the shaft from one another and generating a static pressure for load support. Therefore, hydrostatic bearings have the advantages of high rigidity, anti-vibration, low friction, high precision and error averaging.

Complete hydrostatic bearing structures are quite complicated and difficult to be troubleshot. To overcome the drawbacks, sensors are generally applied in the hydrostatic bearings for structure monitoring, and the hydrostatic bearings are regularly maintained to ensure safety. However, the above-described monitoring technology checks the state of a hydrostatic bearing structure, and issues a warning signal only after the structure malfunctions. Further, regular maintenances need long shut-down time periods and complicated operations. In addition, since the hydrostatic bearings have complicated structures, once an element malfunctions, for example, when a restrictor or sliding block is blocked, a ripple effect appears, and a significant loss comes thereafter.

Therefore, there is a need to provide a hydrostatic bearing monitoring system and a hydrostatic bearing monitoring method that can monitor the performance of a hydrostatic bearing, check the state of the hydrostatic bearing before it malfunctions, and provide a warning function.

### SUMMARY

The present disclosure provides a hydrostatic bearing monitoring system, which comprises: a hydrostatic bearing device, comprising: a bearing body, at least two sliding blocks disposed respectively above two opposite surfaces of the bearing body with a gap formed between each of the sliding blocks and the bearing body, and a restrictor connected to a liquid supply line of a hydraulic unit for sending hydraulic oil of the hydraulic unit to the gap so as to form an oil film; at least one sensor for detecting at least one state parameter of the hydrostatic bearing device; and a computing unit, comprising: a storage module for receiving and storing the state parameter and a plurality of sets of reliability experimental data, a model establishing module for establishing a performance prediction model according to the state parameter, and a comparison module for comparing the performance prediction model with the plurality of sets of reliability experimental data so as to generate a comparison result.

The present disclosure further provides a hydrostatic bearing monitoring method, which comprises the steps of: detecting, by at least one sensor, at least one state parameter of a hydrostatic bearing device and sending the state parameter to a computing unit; establishing, by a model establishing module of the computing unit, a performance prediction model according to the state parameter; and comparing, a comparison module of the computing unit, the performance prediction model with a plurality of sets of reliability experimental data so as to generate a comparison result.

### BRIEF DESCRIPTION OF DRAWINGS

FIG. 1 is a schematic block diagram of a hydrostatic bearing monitoring system according to the present disclosure;

FIGS. 2A to 2C are schematic diagrams of performance prediction models established by the hydrostatic bearing monitoring system according to the present disclosure;

FIGS. 3A to 3D are schematic diagrams of reliability experimental data;

FIG. 4A is a schematic diagram showing comparison between a performance prediction model and the reliability experimental data according to an embodiment of the present disclosure;

FIGS. 4B and 4C are schematic diagrams showing operation of a fuzzy artificial neural network according to different embodiments of the present disclosure; and

FIG. 5 is a schematic flow diagram showing a hydrostatic bearing monitoring method according to the present disclosure.

### DETAILED DESCRIPTION

In the following detailed descriptions, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

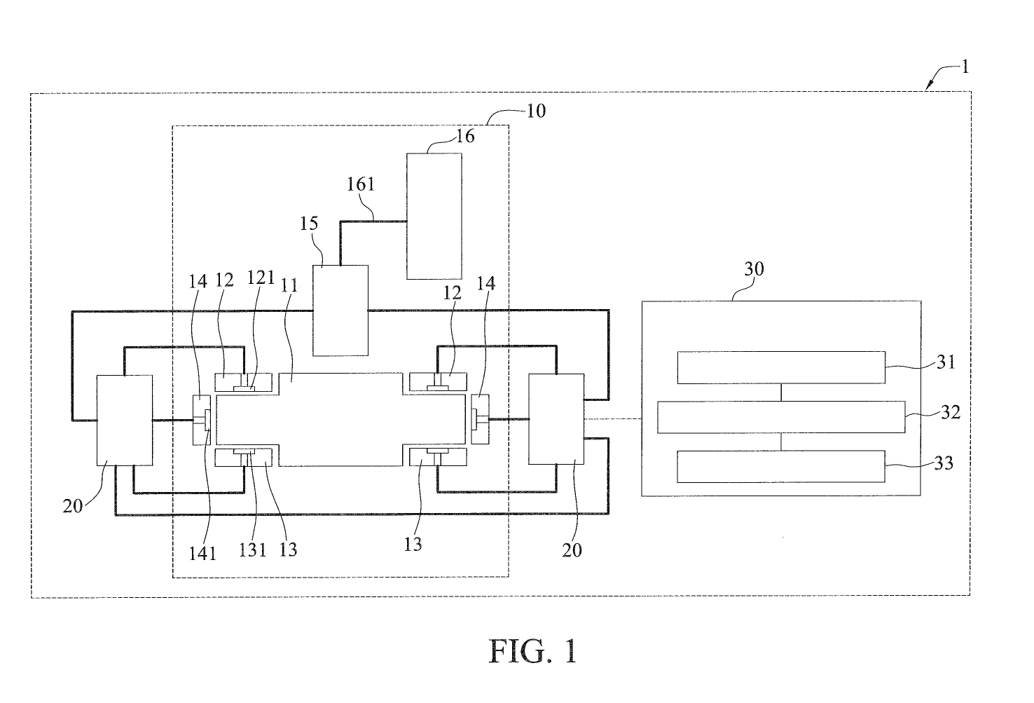

FIG. 1 is a schematic block diagram of a hydrostatic bearing monitoring system 1 according to the present disclosure. Referring to FIG. 1, the hydrostatic bearing monitoring system 1 has a hydrostatic bearing device 10, at least one sensor 20, and a computing unit 30. The hydrostatic bearing device 10 has a bearing body 11, a plurality of sliding blocks 12, 13 and 14, a restrictor 15, and a hydraulic unit 16.

The bearing body 11 can be a hydrostatic bearing structure of any shape, for example, a radial hydrostatic bearing of a cylindrical shape, a tapered shape or a ball shape, or an axial hydrostatic bearing of a sector shape or a ring shape.

At least two sliding blocks provided in pairs are disposed respectively above two opposite surfaces of the bearing body 11. Referring to FIG. 1, the hydrostatic bearing monitoring system 1 has two sliding blocks 12 disposed above upper surfaces of the bearing body 11, and two sliding blocks 13 disposed above lower surfaces of the bearing body 11, or two sliding blocks 14 disposed above side surfaces of the bearing body 11. The sliding blocks 12, 13 and 14 can be disposed in a radial or axial direction according to the structure of the bearing body.

Further, a gap is formed between each of the sliding blocks 12, 13 and 14 and the bearing body 11, and the sliding blocks 12, 13 and 14 have their respective oil chambers 121, 131 and 141 facing the corresponding surface of the bearing body 11.

The restrictor 15 is connected to a liquid supply line 161 of the hydraulic unit 16 for sending hydraulic oil of the hydraulic unit 16 through the liquid supply line 161 to the oil chambers 121, 131 and 141 of the sliding blocks 12, 13 and 14 and the gaps among the sliding blocks 12, 13 and 14 and the bearing body 11, thereby forming an oil film between each of the sliding blocks 12, 13 and 14 and the bearing body 11 and generating a static pressure for load support.

The hydraulic unit 16 can be, but not limited to, a constant pressure oil supply system or a constant flow oil supply system, and the restrictor 15 can be, but not limited to, an orifice restrictor, a capillary restrictor or a variable restrictor.

The sensor 20 is disposed on the liquid supply line 161 between the restrictor 15 and one of the sliding blocks 12, 13 and 14 for detecting at least one state parameter of the hydrostatic bearing device 10.

The sensor 20 can be a pressure sensor, a flow sensor, a displacement sensor such as an eddy current sensor, or a temperature sensor. According to the type of the sensor 20, the state parameter can relate to, for example, oil temperature, oil pressure, oil quantity or oil film gap. In one embodiment, the temperature sensor is disposed at an inlet or outlet of the liquid supply line, and the pressure sensor is connected in parallel with the liquid supply line. Also, the flow sensor is connected in series with the liquid supply line.

In an embodiment, the hydrostatic bearing monitoring system 1 achieves a real-time state monitoring and diagnosis function through combination of the restrictor 15 and the sensor 20. In the hydrostatic bearing device 10, oil is supplied from the hydraulic unit 16 to the restrictor 15 and further to the oil chambers 121, 131 and 141 of the sliding blocks 12, 13 and 14. The oil flow can be automatically adapted to load variation via the pressure drop of the hydraulic oil through the restrictor 15, which is calculated through the following equation:

P=QR,R=R_{restrictor}+R_{sliding block},R_{sliding block}(h)

where P represents the pressure of hydraulic oil, Q represents the flow of the hydraulic oil, R_{restrictor} represents the flow resistance of a restrictor, R_{sliding block} represents the flow resistance of a sliding block, and R_{sliding block (h)} is a function of the gap (h).

If a positive load is applied to the hydrostatic bearing device 10, a positive pressure would be applied on the sliding blocks 12, 13 and 14. Consequently, the gaps between the bearing body 11 and the sliding blocks 12, 13 and 14 are reduced, the flow resistances of the sliding blocks are increased, the flow of the hydraulic oil is reduced, and the pressure of the hydraulic oil is increased so as to adapt to the corresponding load, thereby achieving an automatic compensation effect.

On the contrary, if a negative load is applied to the hydrostatic bearing device 10, a negative pressure would be applied on the sliding blocks 12, 13 and 14. Consequently, the gaps between the bearing body 11 and the sliding blocks 12, 13 and 14 are increased, the flow resistances of the sliding blocks are reduced, the flow of the hydraulic oil is increased, and the pressure of the hydraulic oil is reduced so as to adapt to the corresponding load. Therefore, the hydrostatic bearing monitoring system 1 can determine whether the hydrostatic bearing device malfunctions by cross-comparing the pressure P of the hydraulic oil, the flow Q of the hydraulic oil and the gap H.

The state parameter detected by the sensor 20 is further sent to the computing unit 30 for computation. The computing unit 30 has a storage module 31 for receiving and storing the state parameter and further storing a plurality of sets of reliability experimental data, a model establishing module 32 for establishing a performance prediction model according to the state parameter, and a comparison module 33 for comparing the performance prediction model with the plurality of sets of reliability experimental data so as to generate a comparison result. The computing unit 30 can be a computer or a cloud server. The storage module 31 can be a hard disk, a floppy disk or other portable storage device. The model establishing module 32 and the comparison module 33 are soft programs.

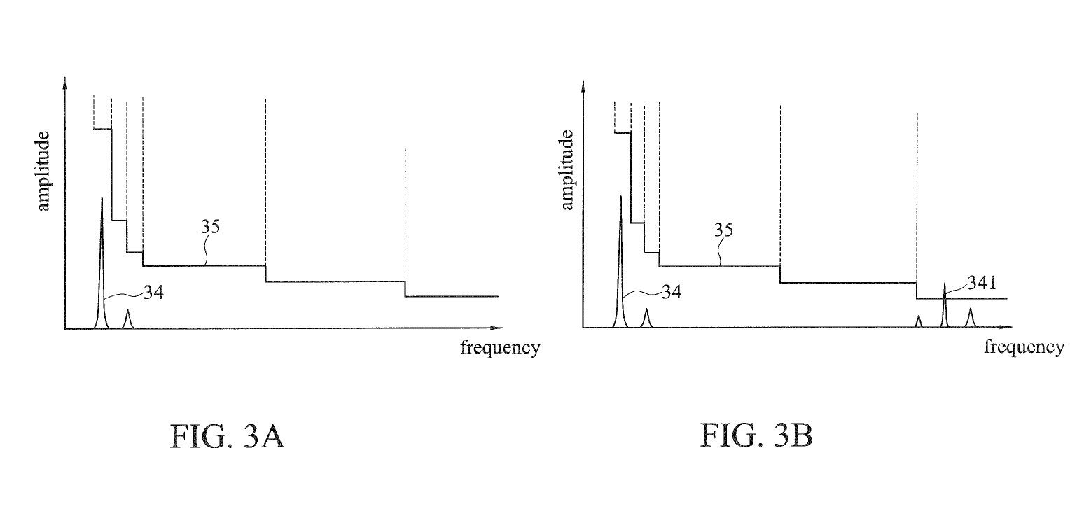

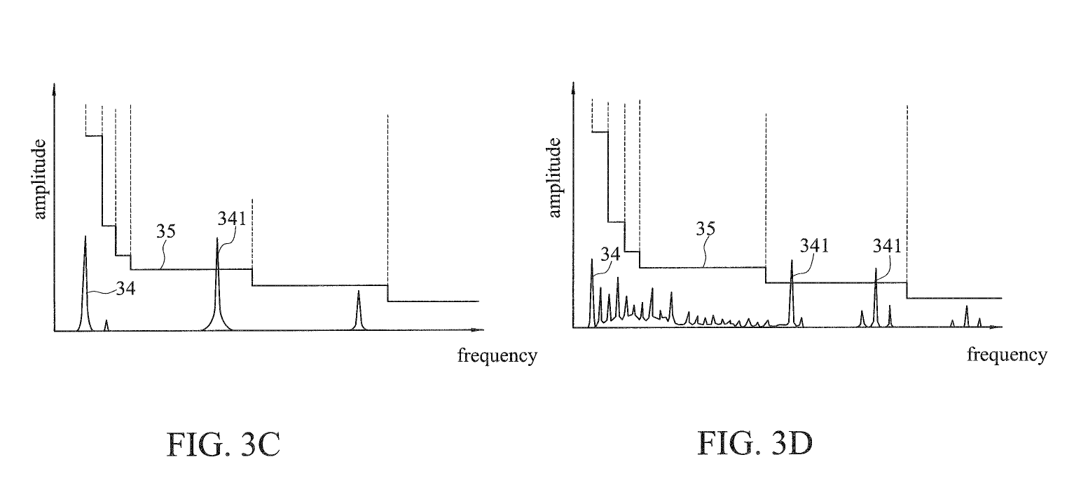

In an embodiment, referring to FIGS. 3A to 3D, the plurality of sets of reliability experimental data are obtained by training a plurality of sets of samples with a fuzzy artificial neural network. The plurality of sets of samples include fault cause signals and occurrence times thereof related to the hydrostatic bearing device. The plurality of sets of reliability experimental data are shown in graphs with frequency on a horizontal axis and amplitude on a vertical axis. Referring to FIG. 3A, a curve 34 represents an operating state of the hydrostatic bearing device 10, and a curve 35 represents acceptable amplitudes within different frequency ranges. If the curve 34 crosses the curve 35, the hydrostatic bearing device 10 is at an abnormal state. Referring to FIG. 3B, the curve 34 has a high frequency component 341 that crosses the curve 35, and the hydrostatic bearing device 10 is at an abnormal state. A similar situation occurs in FIGS. 3C and 3D. Through training of the fuzzy artificial neural network, different reliability experimental data can be related to different fault causes such as blocking, impacting, wearing and oil deterioration, thereby facilitating subsequent comparison.

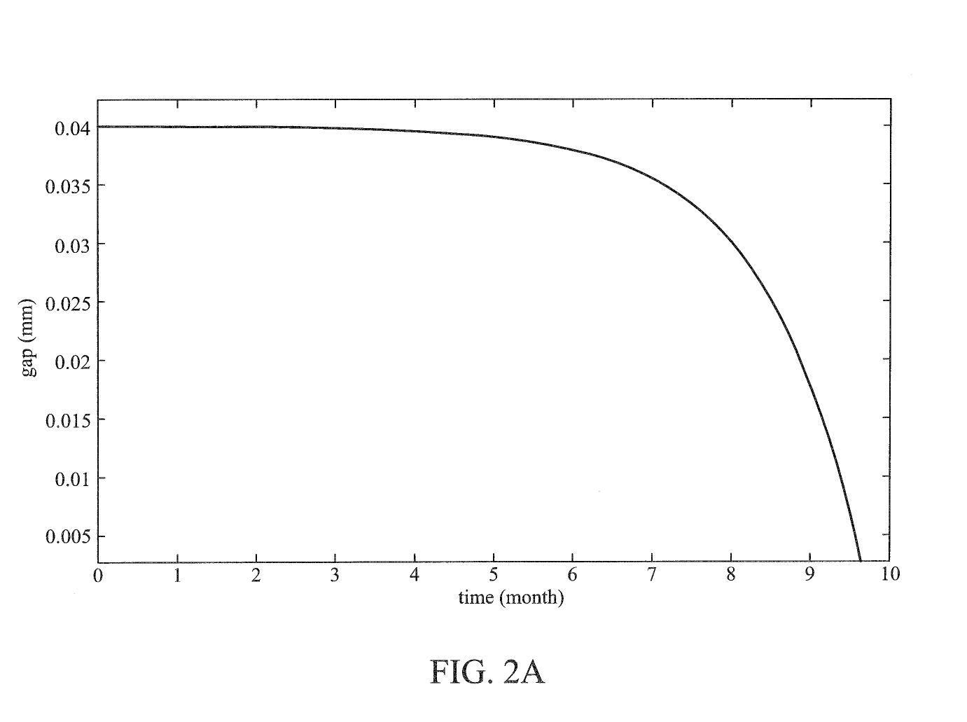

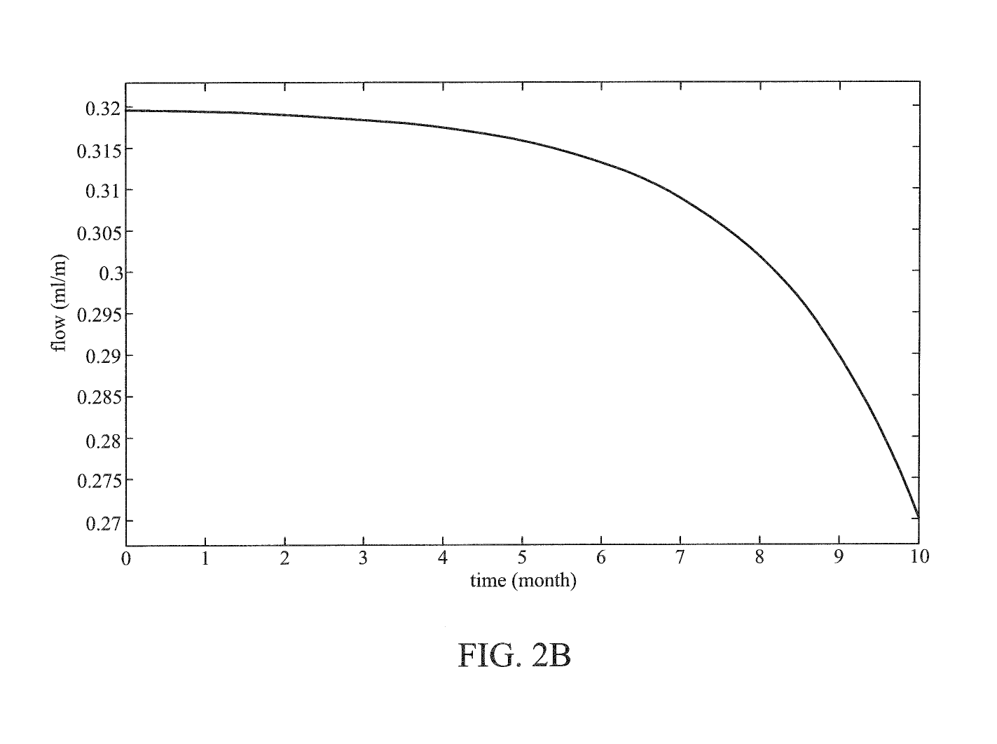

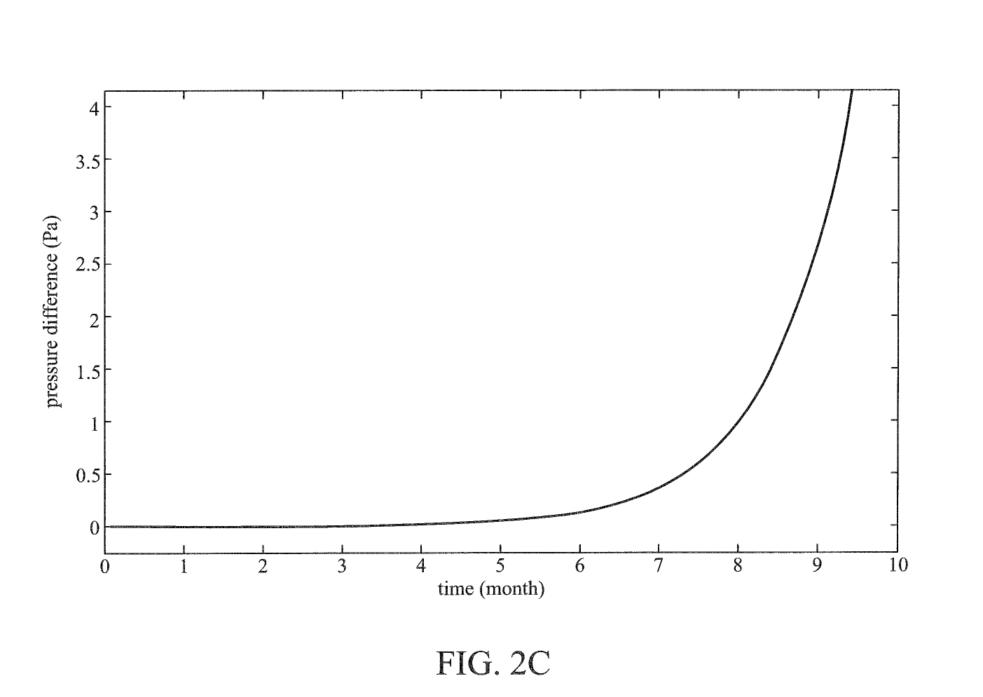

The model establishing module 32 is used to establish a performance prediction model according to the state parameter. The performance prediction model relates to a performance state representing model of a gap (as shown in FIG. 2A), a flow (as shown in FIG. 2B) or a pressure difference (as shown in FIG. 2C) of the hydrostatic bearing device during an entire life cycle thereof.

Further, the performance prediction model can be a pressure state model of the hydraulic oil, a flow state model of the hydraulic oil, a state model of the gap between a sliding block and a corresponding sliding surface, or a high frequency demodulation model of displacement signals.

In an embodiment, the performance prediction model detects complete history records established during each of the following time periods: during fabrication of the hydrostatic bearing; after fabrication of the hydrostatic bearing and before use of the hydrostatic bearing; during use of the hydrostatic bearing; during non-use of the hydrostatic bearing; and during operation of the hydrostatic bearing. Through long-time monitoring of the state parameter of the hydrostatic bearing in each of the time periods, a performance prediction model relating to variation of the pressure difference, flow or gap during the entire life cycle of the hydrostatic bearing device can be established.

The comparison module 33 is used to compare the performance prediction model with the plurality of sets of reliability experimental data so as to obtain a comparison result. Since having different performances at different positions and regions, modules of the hydrostatic bearing are compared with the performance prediction model at each time period so as to obtain the remaining life time of the modules at different positions and regions and predict when a maintenance is required, whether an overload occurs, whether an element such as the restrictor fails, or whether an installation accuracy is acceptable. As such, a comparison result is provided. In addition, the hydrostatic bearing monitoring system 1 can provide a compensation notification, maintenance notification or warning function according to the comparison result.

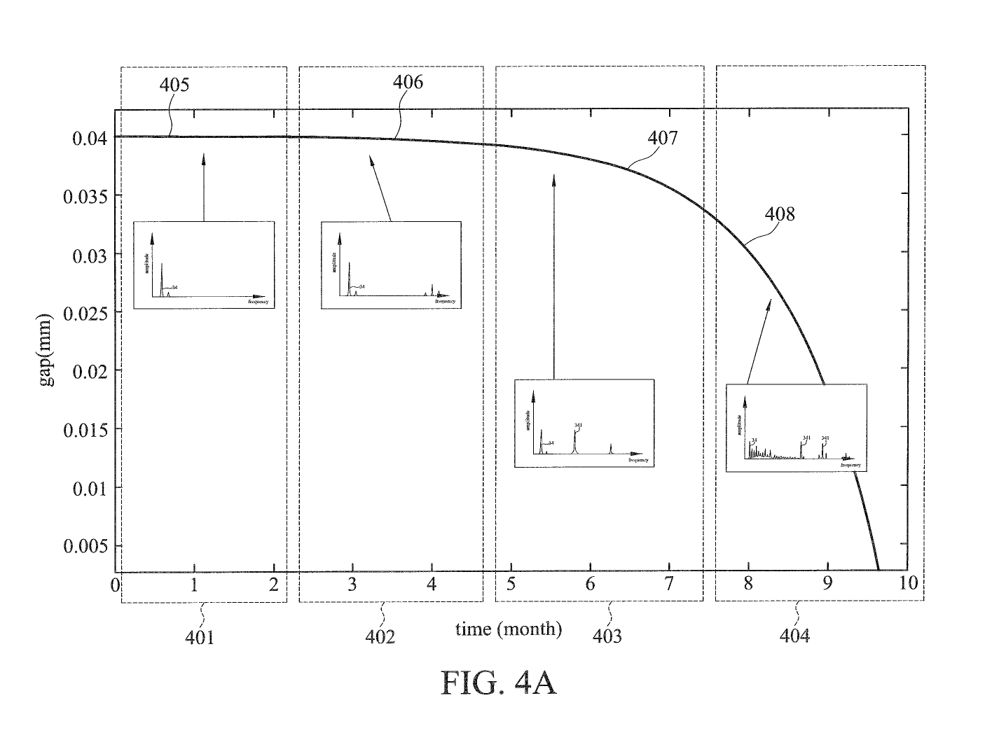

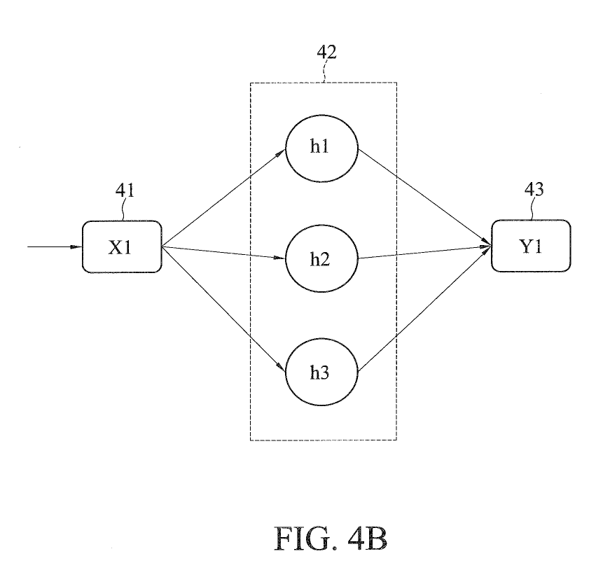

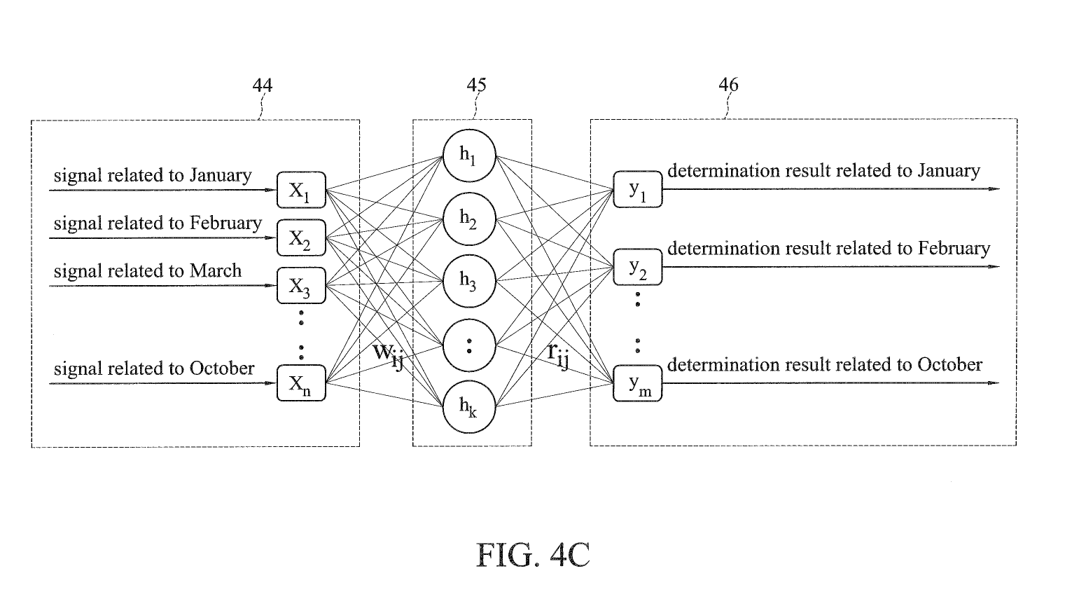

In an embodiment, referring to FIG. 4A, the performance prediction model of FIG. 2A relating to the gap is exemplified. Referring to FIG. 4A, in a block 401 of FIG. 4A, a curve portion 405 in the block 401 is compared with the reliability experimental data of FIG. 3A; in a block 402 of FIG. 4A, a curve portion 406 in the block 402 is compared with the reliability experimental data of FIG. 3B (for example, a decuple-frequency component occurs); in a block 403 of FIG. 4A, a curve portion 407 in the block 403 is compared with the reliability experimental data of FIG. 3C (for example, quintuple- and decuple-frequency components occur); and in a block 404 of FIG. 4A, a curve portion 408 in the block 404 is compared with the reliability experimental data of FIG. 3D (for example, more multiplied frequency components occur). As such, a comparison result is obtained.

In an embodiment, referring to FIG. 4B, the fuzzy artificial neural network has an input layer 41 for inputting an original signal, i.e., a state parameter, a hidden layer 42 for performing an interactive computation on the performance prediction model established according to the original signal and the reliability experimental data, and an output layer 43 for outputting an analyzing result. Referring to FIG. 4C, the input layer 44 can have a plurality of input sources (for example, signals related to different months), and the output layer 46 can output a plurality of analyzing results (for example, related to different months). A diagnosis model established by the hidden layer 45 can consist of a plurality of performance prediction models.

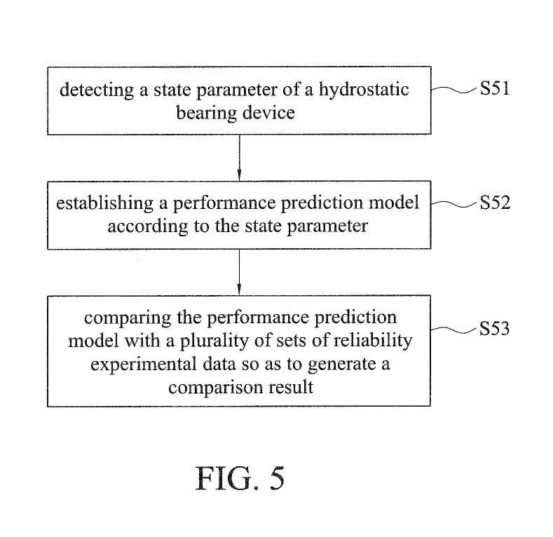

FIG. 5 is a schematic flow diagram showing a hydrostatic bearing monitoring method according to the present disclosure. Referring to FIG. 5, the method includes the steps of detecting a state parameter of a hydrostatic bearing device, in step S51; establishing a performance prediction model according to the state parameter, in step S52; and comparing the performance prediction model with a plurality of sets of reliability experimental data so as to generate a comparison result, in step S53.

In one embodiment, in step S51, at least one sensor is used to detect at least one state parameter of a hydrostatic bearing device, and sends the state parameter to a computing unit. The sensor can be a pressure sensor, a flow sensor, a displacement sensor or a temperature sensor. The state parameter can relate to oil temperature, oil pressure, oil quantity or oil film gap.

In step S52, a model establishing module of the computing unit establishes a performance prediction model according to the state parameter. The performance prediction model can relate to variation of pressure difference, flow or gap during an entire life cycle of the hydrostatic bearing device.

In step S53, a comparison module of the computing unit compares the performance prediction model with a plurality of sets of reliability experimental data so as to generate a comparison result. The plurality of sets of reliability experimental data are obtained by training a plurality of sets of samples with a fuzzy artificial neural network. The plurality of sets of samples include fault cause signals and occurrence times thereof related to the hydrostatic bearing device.

According to the present disclosure, various kinds of sensors can be used to detect various state parameters of a hydrostatic bearing device so as to allow a computing unit to establish a performance prediction model and compare the performance prediction model with a plurality of sets of reliability experimental data that are pre-obtained by training of an artificial neural network, thereby obtaining variation of performance of the hydrostatic bearing device and providing a warning function related to accuracy, efficiency, lifetime and fault causes. Therefore, the present disclosure facilitates to obtain the life cycle of the product, achieve real-time monitoring and maintenance, reduce the cost and improve the product yield.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A hydrostatic bearing monitoring system, comprising:
a hydrostatic bearing device, comprising:
a bearing body;
at least two sliding blocks disposed respectively above two opposite surfaces of the bearing body with a gap formed between each of the sliding blocks and the bearing body;
a hydraulic unit having a liquid supply line; and
a restrictor connected to the liquid supply line of the hydraulic unit and configured to send hydraulic oil of the hydraulic unit to the gap to form an oil film;
at least one sensor configured to detect at least one state parameter of the hydrostatic bearing device; and
a computing unit, comprising:
a storage module configured to receive and store the state parameter and a plurality of sets of reliability experimental data;
a model establishing module configured to establish a performance prediction model according to the state parameter; and
a comparison module configured to compare the performance prediction model with the plurality of sets of reliability experimental data to generate a comparison result.

2. The hydrostatic bearing monitoring system of claim 1, wherein the sensor is one or any combination of a pressure sensor, a flow sensor, a displacement sensor and a temperature sensor.

3. The hydrostatic bearing monitoring system of claim 1, wherein the state parameter relates to one or any combination of oil temperature, oil pressure, oil quantity and oil film gap.

4. The hydrostatic bearing monitoring system of claim 1, wherein the plurality of sets of reliability experimental data are obtained by training a plurality of sets of samples with a fuzzy artificial neural network, and the plurality of sets of samples comprise fault cause signals and occurrence times thereof related to the hydrostatic bearing device.

5. The hydrostatic bearing monitoring system of claim 1, wherein the sensor is disposed on the liquid supply line between the restrictor and one of the sliding blocks.

6. The hydrostatic bearing monitoring system of claim 1, wherein each of the sliding blocks is disposed above a corresponding surface of the bearing body in an axial direction or a radial direction.

7. The hydrostatic bearing monitoring system of claim 1, wherein the performance prediction model relates to a performance state representing model of a pressure difference, a flow, or a gap of the hydrostatic bearing device during an entire life cycle thereof.

8. A hydrostatic bearing monitoring method, comprising:
detecting, by at least one sensor, at least one state parameter of a hydrostatic bearing device and sending the state parameter to a computing unit;
establishing, by a model establishing module of the computing unit, a performance prediction model according to the state parameter; and
comparing, by a comparison module of the computing unit, the performance prediction model with a plurality of sets of reliability experimental data to generate a comparison result.

9. The hydrostatic bearing monitoring method of claim 8, wherein the plurality of sets of reliability experimental data are obtained by training a plurality of sets of samples with a fuzzy artificial neural network, and the plurality of sets of samples comprise fault cause signals and occurrence times thereof related to the hydrostatic bearing device.

10. The hydrostatic bearing monitoring method of claim 8, wherein the sensor is one or any combination of a pressure sensor, a flow sensor, a displacement sensor and a temperature sensor.

11. The hydrostatic bearing monitoring method of claim 8, wherein the state parameter relates to one or any combination of oil temperature, oil pressure, oil quantity and oil film gap.

12. The hydrostatic bearing monitoring method of claim 8, wherein the performance prediction model relates to a performance state representing model of a pressure difference, a flow or a gap of the hydrostatic bearing device during an entire life cycle thereof.
